(19) United States
(12) Patent Application Publication
(10) Pub. No.: US 2026/0090940 A1
(43) Pub. Date: Apr. 2, 2026

(54) TILTING SYSTEM FOR AN OPERATING TABLE

(71) Applicant: Baxter Medical Systems GmbH + Co. KG, Saalfeld (DE)

(72) Inventors: Andreas Zapf, Saalfeld (DE); Norman Töpel, Saalfeld (DE)

(21) Appl. No.: 19/339,691

(22) Filed: Sep. 25, 2025

(30) Foreign Application Priority Data
Sep. 30, 2024 (EP) 24203755.4

(51) Int. Cl. A61G 13/04

(52) U.S. Cl. CPC A61G 13/04

(57) ABSTRACT

A tilting system for an operating table includes a frame for supporting a support surface for a patient and a tilting mechanism. The tilting mechanism is coupled to the frame. The tilting mechanism is configured to rotate the frame about a dynamic pivot point. The dynamic pivot point follows a predetermined path.

### CROSS-REFERENCE TO RELATED APPLICATIONS

This application claim priority to European Patent Application No. 242203755.4, filed Sep. 30, 2024, the entire disclosure of which is incorporated hereby reference in its entirety.

### BACKGROUND

The present disclosure relates to a tilting system for an operating table. The present disclosure also relates to an operating table comprising a tilting system and a method for controlling an operating table.

As minimally invasive and robot-assisted surgeries have become increasingly common, the demands for operating table functionality have also grown. Advanced surgical techniques often require precise patient positioning and tilting to use gravity to move organs out the way. This allows improvedangle access to the point of interest inside the patient.

In order to provide improved access, it is known to adjust the position of an operating table to achieved desired patient orientations during surgical procedures. Conventional operating tables typically have a first mechanism for tilting or rotating the support surface around a longitudinal axis of the operating table and a second, separate, mechanism for displacing the support surface along a transverse axis of the operating table.

Further, conventional operating tables typically have accessory rails mounted thereto. Accessory rails extending along the sides of the table allow for the mounting and positioning of various surgical tools, monitors, and robotic arm systems.

This tilting motion can present challenges. In particular, as the table is tilted, any attached accessories, particularly those attached below the table, may come into close proximity with, or may even collide with, the table base or other surrounding equipment.

Therefore, there is a desire for an improved tilting system for an operating table.

### SUMMARY

The present disclosure includes one or more of the features recited in the appended claims and/or the following features which, alone or in any combination, may comprise patentable subject matter.

According to a first aspect of the present disclosure, there is provided a tilting system for an operating table. The tilting system comprises a frame for supporting a support surface for a patient. The tilting system further comprises a tilting mechanism coupled to the frame. The tilting mechanism is configured to rotate the frame about a dynamic pivot point which follows a predetermined path.

The tilting system is a system for tilting an operating table to adjust patient positioning during surgical procedures, for example. The tilting system according to the present disclosure allows for a single tilting mechanism to both laterally displace and rotate the frame. In other words, the tilting mechanism is a combined mechanism. Providing a single combined tilting mechanism reduces the space occupied by the tilting mechanism. Further, providing a single tilting mechanism, which can both rotate and laterally displace the frame, simplifies existing mechanisms.

The present inventors have appreciated that a fixed pivot point presents limitations in terms of patient positioning and accessibility in comparison to the system according to the present disclosure. The dynamic pivot point is a pivot point that is not stationary or fixed in space relative to a pedestal or column of a surgical table. Instead, the tilting mechanism is configured such that the frame rotates about a pivot point that is moving or shifting as the frame rotates or tilts about said pivot point. The pivot point moves along or follows a predetermined path. In other words, the range of positions of the dynamic pivot point throughout the rotation of the frame are predetermined or already set. Providing a dynamic pivot point increases the range or motion of the frame and as such the support surface. The dynamic pivot point provides a tilting system with improved maneuverability.

The path or route of the dynamic pivot point may be set by the configuration of the tilting mechanism. In other words, the path or route of the dynamic pivot point may be determined by the mechanical arrangement of the tilting mechanism. The tilting mechanism may provide a constant predetermined path or route, that is, the tilting mechanism may enable only one predetermined path. Alternatively, the path or route of the dynamic pivot point may be set computationally, and enabled by a tilting mechanism controller. In other words, the tilting mechanism may be capable of providing a plurality of predetermined paths or routes.

The pivot point may be referred to as a moving pivot point or a changing pivot point.

Further still, the tilting system according to the present disclosure reduces or lowers the risk of collision between accessories of an operating table and the structure of the operating table, such as a pedestal or column. This is because rotating the frame about a dynamic pivot point ensures the necessary clearance between the accessories and the table structure is maintained in each rotational position. In particular, the tilting mechanism according to the present disclosure may be configured to increase the volume within which accessories can be attached to the table without colliding with the pedestal or column during rotation. This allows for larger accessory parts, in particular, robotic arms, to be positioned along an accessory rail even when the support surface is in a tilted position.

Even further still, the increase in range of motion provided for by the tilting system according to the present disclosure, also reduces the likelihood of accessories being obstructed during rotation.

The frame may be a rectangular support member. In use, the frame is arranged or positioned above the tilting mechanism. The frame is configured to support a support surface.

The support surface is for supporting the patient during the surgical procedure. The support surface may be referred to as an operating table support surface. The support surface may be fixed to the frame. The tilting mechanism may be configured to rotate the frame about a longitudinal axis of an operating table. This provides precise patient positioning for various surgical procedures. The tilting mechanism may be configured such that, in use, the patient is rotated from side to side. In other words, the tilting mechanism may be configured to provide lateral tilting of the frame, and thus the support surface.

The tilting mechanism may be configured to displace the frame, transversely to the longitudinal axis of an operating table, while it rotates about the dynamic pivot point. This provides a single mechanism that can provide both movements (rotational and lateral shift), which in turn reduces the space occupied by the tilting mechanism. Further, the tilting mechanism allows for both movements to occur simultaneously. In this manner, the rotation occurs while the displacement along the transverse axis occurs. Further still, the transverse displacement or lateral shift, during rotation, allows for a greater tilt angle. Further still, this combined movement creates additional clearance for accessories and robotic arms. This reduces the risk of collision with, or interference of, an operating table pedestal, for example.

The dynamic pivot point may be displaced from the frame in the direction of the tilting mechanism. The dynamic pivot point may be spaced from the frame in the direction of the tilting mechanism. In this manner, in use, the dynamic pivot point may sit below the frame. This is in comparison to conventional operating tables whereby the table surface rotates about a fixed pivot point which is located near the center of the frame or support surface. Further, displacing the pivot point from the frame allows for a wider range of motion.

During rotation, the dynamic pivot point may move along the predetermined path in a direction of the tilting.

The tilting mechanism may further comprise a chassis. The chassis may be for coupling the tilting system to a pedestal of an operating table. The tilting mechanism may comprise at least one link set. The at least one link set may comprise at least one link pivotably coupled at a first end to the chassis and at a second end to the frame.

This configuration provides a stable connection between the tilting mechanism and the frame, ensuring smooth and controlled tilting movements. Further, providing at least one link set coupled in this way provides a means of controlling or determining the predetermined path. The configuration of the at least one link set may define the predetermined path. The configuration of the at least one link set may ensure that the frame rotates about the dynamic pivot point.

A pedestal may be a column configured to support the operating table. The pedestal may be connected to a base. The pedestal may provide stability and strength to the overall structure.

The chassis may be fixed relative to a pedestal of the operating table. The chassis may be a gimbal or cardan. The chassis may extend from a first lateral side of the tilting system to a second lateral side of the tilting system. The chassis and the pedestal may be two separate members couplable to one another. Alternatively, the chassis and the pedestal may be integral.

The tilting mechanism may comprise a first link set disposed on a first lateral side of the tilting mechanism. The tilting mechanism may comprise a second link set disposed on a second lateral side of the tilting mechanism. Providing two link sets on opposing sides of the tilting mechanism or frame enhances stability and load distribution during rotation.

The link set may comprise two links. Each link may be pivotably coupled at a first end to the chassis. Each link may be pivotably coupled at a second end to the frame. The two links may determine or control the predetermined path of the dynamic pivot point. The length of each of the two links may determine or set the predetermined path of the dynamic pivot point. Preferably, each of the two links has an equal length. The distance between the respective ends of each link may also determine or set the predetermined path of the dynamic pivot point. The relative positioning of each of the links may determine or set the predetermined path of the dynamic pivot point. Therefore, the predetermined path which the dynamic pivot point follows can be set by the configuration and dimensions of the links. The link arrangement may be according to the “Robert's mechanism” principles. Preferably, chassis and the frame are configured such that the distance between the first ends of the links is less than the distance between the second end of the links.

The dual-link configuration ensures that the frame is laterally displaced as it rotates. Further, the dual-link configuration provides additional support and control over the rotation. Further, this configuration improves the precision of the system. The link set may comprise three links. The link set may comprise four links.

The tilting system may include a carrier. The carrier may be pivotably coupled to the chassis. The carrier may be configured to support a shaft. The shaft may be coupled, adjacent each end, to the frame. The shaft may be configured to move linearly, relative to the carrier, along a transverse axis of the frame while the frame rotates about the dynamic pivot point.

The carrier may be coupled to a pivot point on the chassis. The carrier may comprise a casing for the shaft. The shaft may be able to move linearly within the carrier. This arrangement ensures alignment is maintained between the shaft and the frame. The shaft may be coupled to the frame via connecting members.

The carrier and the shaft may be configured to form a linear actuator. A linear actuator provides precise control over the movement of the frame and enables automated positioning of the frame and as such the operating table. The shaft of the linear actuator may be formed as a leadscrew, the carrier comprising a corresponding thread for receiving the leadscrew and forming the linear actuator. The leadscrew converts rotational motion into linear motion. As such, the leadscrew assists in providing precise linear movement.

The linear actuator may be positioned substantially parallel to a top surface of the frame.

The carrier may be configured such that the distance between the linear actuator and the top surface of the frame remains substantially constant during rotation. The carrier may therefore ensure that the distance between a central point of the support surface and the linear actuator is maintained or constant during rotation.

The carrier may be coupled between two portions of the chassis. The carrier may be coupled to a pivot point on each portion of the chassis. The carrier may be coupled to each pivot point on each portion of the chassis via a bearing. The carrier, and in particular, the bearing may be configured to allow up to about 0.5 mm of vertical movement of the linear actuator relative to the chassis. The carrier, and in particular, the bearing may be configured to allow up to about 0.3 mm of vertical movement of the linear actuator relative to the chassis.

The tilting system may further comprise a motor coupled to the frame. The motor may be configured to drive the linear actuator. This provides automated control of the tilting mechanism. As such, this provides a system that is easy to use and reduces the manual burden on users, such as medical staff.

The tilting system may comprise a gearbox, or transmission. The gearbox or transmission may be configured to adjust the output of the motor.

The motor may be arranged so that in use, it is positioned between the tilting mechanism and a support surface supported by the frame. In other words, the motor may be positioned above the tilting mechanism. In particular, the motor may be located within or housed within the frame. This minimizes the space occupied by the motor, in comparison to known tilting systems.

In alternative embodiments, the tilting mechanism may comprise six linear actuators. Each linear actuator may be coupled at a first end to a base. Each linear actuator may be coupled to a second end to the frame. This configuration may provide six degrees of freedom. This allows for complex positioning of the frame and as such the support surface. Further, this configuration may allow for the tilting mechanism to be attached directly to a base, replacing a column or pedestal typically required. As will be appreciated, the six linear actuators may be provided in two interleaved sets, a first set having their first ends coupled to the base and a second set having their second ends coupled to the base.

The tilting mechanism may also be configured to provide translation movement in the y and z directions. The tilting mechanism may also be configured to provide rotational movement about an x and z axis. This allows movement of the support surface to the desired position. The tilting mechanism may be configured to provide lift movement only, i.e., all six actuators will be extended or retracted synchronously. The tilting mechanism may be configured to tilt the frame about a transversal axis. The tilting mechanism may be configured to tilt the frame about a longitudinal axis of the operating table. The tilting mechanism may pivot the frame left and right. The tilting mechanism may be able to rotate the frame about a dynamic pivot point. The predetermined path may be determined by the controller.

The six linear actuators may be arranged in a hexapod configuration. This provides multi-axis movement capabilities. Further, this provides a system that can move the support surface as required, while reducing the amount of space occupied by the tilting mechanism. Further still, this arrangement may provide a rigid and stable tilting mechanism.

The actuators may be hydraulic, pneumatic, or electromechanical.

The tilting mechanism may comprise six motors. Each motor may be coupled to a respective linear actuator. This may allow for independent control of each actuator.

The tilting system may further comprise a controller configured to control the six linear actuators to rotate the frame about the dynamic pivot point. The controller can coordinate the extension and retraction of the linear actuators to achieve the desired tilting angles and positions. The controller may independently control each actuator. This enhances the ease of use and reduces manual effort for medical staff, while ensuring smooth and controlled tilting movements.

Each motor may be coupled to a gearbox or transmission and leadscrew, individually controlled by a controller.

The tilting mechanism may be configured such that the distance between a central point of the frame and the linear actuator is substantially constant throughout rotation.

The tilting mechanism may be configured such that the lateral displacement of the frame is such that, when there are accessories coupled to the frame, there is a clearance between said accessories and a pedestal of the operating table. The tilting mechanism may be configured such that the lateral displacement of a central point of the frame from a resting position to a tilted position is up to about 100 mm.

The tilting mechanism may be configured such that the angle of rotation is up to about 40 degrees. The tilting mechanism may be configured such that the angle of rotation is up to about 30 degrees. The tilting mechanism may be configured such that the angle of rotation is up to about 25 degrees.

The tilting system according to the present disclosure may be retrofitted to existing operating tables and/or used with existing support surfaces. This may allow for existing operating tables to be upgraded, which would reduce new material costs. In particular, the tilting mechanism may be configured to be coupled to a pedestal or column. The frame may be configured to be coupled to a support surface.

According to a second aspect of the present disclosure, there is provided an operating table. The operating table comprises a tiling system as described herein. The operating table further comprises a support surface for a patient. The support surface is coupled to the frame.

The support surface may be the patient bed or surgical table. The support surface may be fixed to a top surface of the frame. The support surface may be fixed to the frame such that position of the support surface is dictated by the position of the frame. The frame may be coupled to a central point of the support surface.

The operating table may further comprise a pedestal. The pedestal may be coupled to the tilting system. The tilting mechanism may be positioned between the pedestal and the frame. The pedestal may be a column. The pedestal may be coupled to a base for supporting the operating table. The pedestal may be adjustable in height. The chassis of the tilting mechanism may be fixed to the pedestal.

The operating table may comprise at least one accessory rail. The accessory rail may be coupled to the frame. The accessory rail may be coupled to the support surface of the operating table. The accessory rail may be coupled to a longitudinal side of the support surface. The accessory rail may be configured to support accessories. The operating table may comprise at least one accessory. The accessory may be mounted to the accessory rail. The at least one accessory may be a surgical equipment or a robotic arm for performing robotic-assisted surgical procedures.

The operating table according to the second aspect, comprising the tilting system according to the present disclosure, prevents collision between the accessories and the pedestal, while still providing the desired tilt of the support surface. The operating table according to the present disclosure also allows for easy access to the accessories during the procedure, even when the tilting mechanism is at or near a maximum tilt angle.

According to a third aspect of the present disclosure, there is provided a method of controlling an operating table. The method comprises rotating a support surface for a patient about a dynamic pivot point. The dynamic pivot point follows a predetermined path.

The method allows for precise and complex movements of an operating table and improved patient positioning during surgical procedures while reducing the risk of collisions with accessories and equipment.

The method may comprise activating at least one motor, wherein the motor is configured to drive a linear actuator.

The method may comprise displacing the support surface transversely to a longitudinal axis of an operating table, while rotating the support surface about the dynamic pivot point.

It will be appreciated that features described in relation to one aspect of the present disclosure may also be applied equally to all of the other aspects of the present disclosure. Features described in relation to the first aspect of the present disclosure may be applied equally to the second aspect of the present disclosure and vice versa. Features of the tilting system described in relation to the first aspect may be applied, mutatis mutandis, to the operating table of the second, for example.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 shows a front view of an example tilting system for an operating table according to the present disclosure;

FIG. 2 shows a perspective view of a tilting mechanism of the tilting system of FIG. 1;

FIG. 3 shows a top view of the tilting mechanism of FIG. 2;

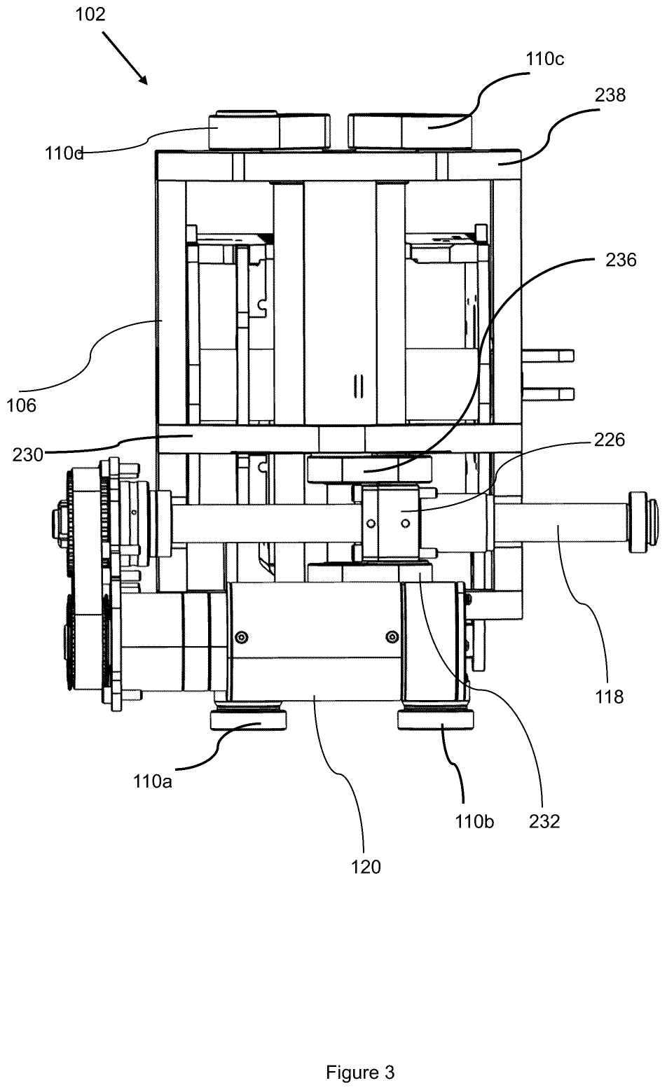

FIG. 4 shows a front view of the tilting system of FIG. 1 coupled to a pedestal;

FIG. 5 shows the tilting system rotated about a dynamic pivot point;

FIG. 6 shows a schematic of a preterminal path of the dynamic pivot point;

FIG. 7 shows the tilting system comprises a box for storing accessories;

FIG. 8 shows a front view of an alternative example tilting system for an operating table according to the present disclosure;

FIG. 9 shows the tilting system of FIG. 8 laterally displaced;

FIG. 10 shows the tilting system of FIG. 8 rotated about the longitudinal axis of an operating table;

FIG. 11 shows the tilting system of FIG. 8 in a retracted position; and

FIG. 12 shows the tilting system of FIG. 8 laterally displaced and rotated.

### DETAILED DESCRIPTION

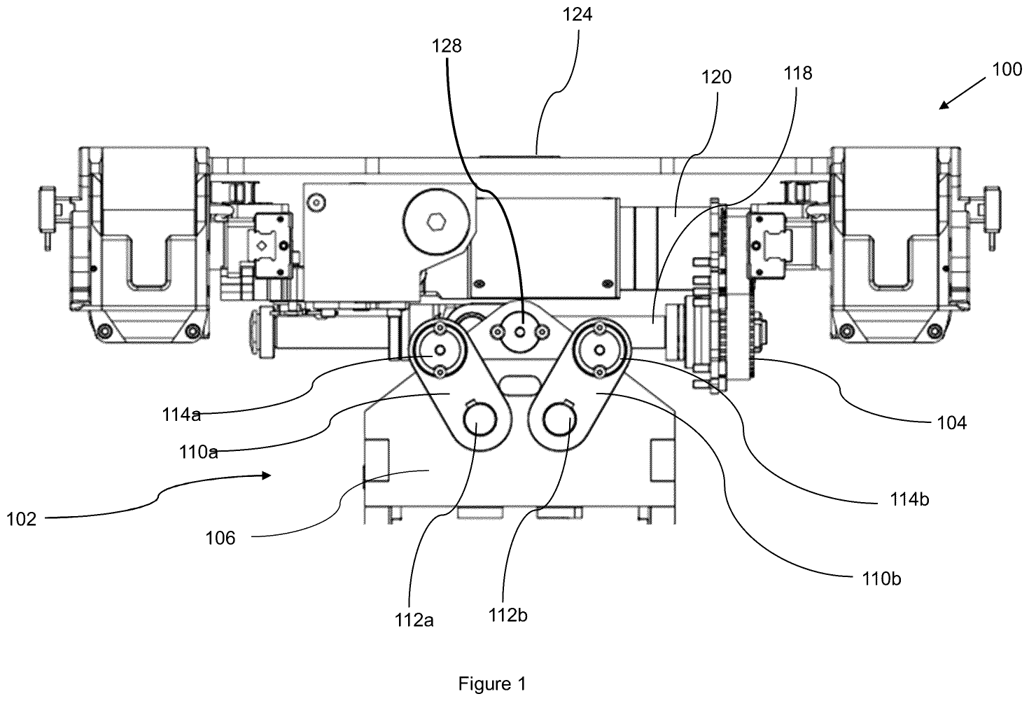

FIG. 1 illustrates an example of a tilting system 100 for an operating table. The tilting system 100 comprises a frame 104 and a tilting mechanism 102. The frame 104 is configured to support a support surface for a patient. The support surface is a top surface of an operating table on which a patient is supported during a surgical procedure. The support surface is fixed to the frame 104, such that when the frame 104 rotates, the support surface rotates.

The tilting mechanism 102 is coupled to the frame 104. The frame 104 comprises a center point 124. The tilting mechanism 102 is located below the frame 104. The tilting mechanism 102 is configured to rotate the frame 104 about a dynamic pivot point. The dynamic pivot point follows a predetermined path. The predetermined path can be set according to the specific requirements of the operating table.

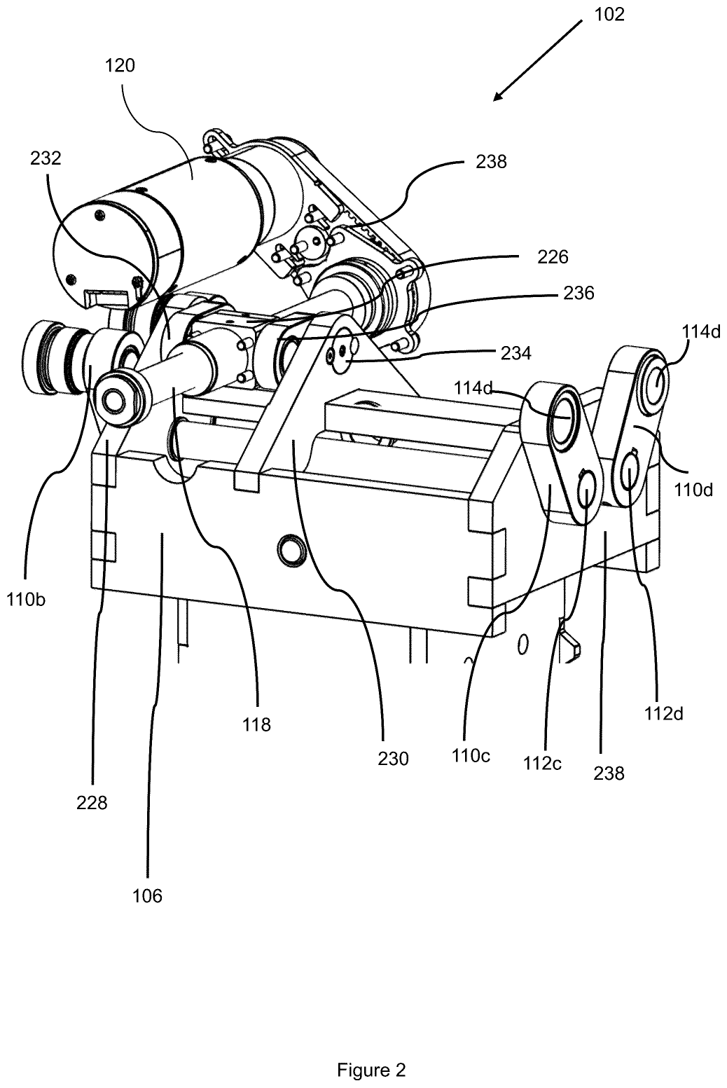

The tilting mechanism 102 system comprises a chassis 106, shown in more detail in FIG. 2. The chassis 106 is a fixed member. The frame 104 moves relative to the chassis 106.

The tilting mechanism 102 comprises two link sets, one link set 110a, 110b is illustrated in FIG. 1. As shown in FIG. 2, a first link set 110a, 110b is disposed on a first lateral side 228 of the chassis 106. A second link set 110c, 110d is disposed on a second lateral side 238 of the chassis 106. Each link set comprises two links 110a, 110b, 110c, 110d. As shown in FIG. 1 with regards to the first link set, each link 110a, 110b is pivotably coupled at a first end 112a, 112b to the chassis 106 and at a second end 114a, 114b to the frame 104. This arrangement of the link set allows the frame 104 to rotate about the dynamic pivot point while also enabling transverse displacement of the frame 104 relative to the chassis 106. The titling system 100 further comprises a motor 120. The motor 120 is coupled to and housed within the frame 104. Thus, the motor 120 is configured to rotate relative to the chassis 106 together with the frame 104. The motor 120 is configured to drive a linear actuator. As shown in FIG. 2, the tilting mechanism 102 comprises a gearbox, or transmission, 238 configured to control the output of the motor 120, and as such the speed of the linear actuator.

The linear actuator is formed from a shaft 118, in the form of a leadscrew, and a carrier 226 comprising a threaded nut portion. The shaft 118 is configured to move linearly, relative to the carrier 226, along a transverse axis of the frame 104, to cause the frame 104 to rotate about the dynamic pivot point. The carrier 226 is pivotably coupled to the chassis via bearings 128 and 234 provided in respective first portion 228 of the chassis 106 and second portion 230 of the chassis 106. The carrier 226 further comprises two carrier links 232 and 236 which pivotably couple the carrier to the chassis, and to which the threaded nut portion is coupled. The carrier link portions are configured to allow minimal vertical movement of the carrier 226 and the shaft 118 relative to the chassis as the frame rotates. In this example, the carrier link portions are configured to allow about 0.3 mm of vertical movement. Configuring the relative positions of the carrier and the links in this way significantly reduces relative vertical movement between the linear actuator and the chassis. This reduction in movement reduces the potential for binding of the linear actuator during use.

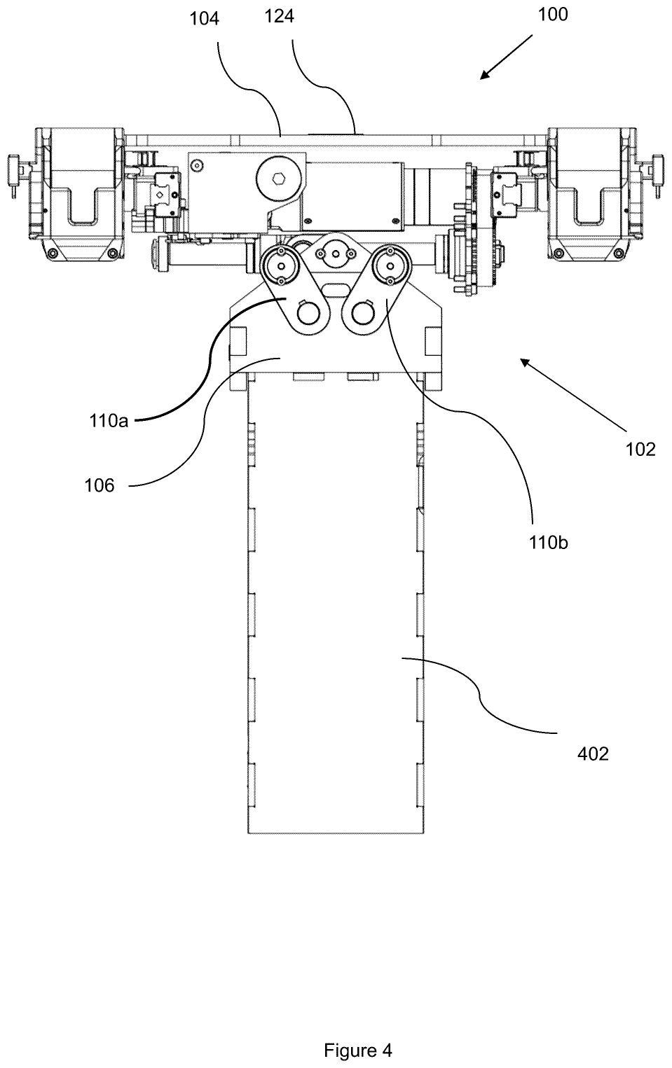

As shown in FIG. 4, the tilting system 100 is coupled to a pedestal 402. In particular, the chassis 106 of the tilting mechanism 102 is fixed to a first end of the pedestal 402. The pedestal 402 is a column. Although not shown, the pedestal 402 may be coupled, at a second end, to a base member. The base member is configured to support an operating table. The pedestal 402 may be adjustable in height. In this example, the pedestal 402 and the chassis 106 are separate parts. However, in alternative examples, the pedestal 402 and the chassis 106 may be formed from a single part.

The tilting mechanism 102 is configured to rotate the frame 104 about the dynamic pivot point. The dynamic pivot point sits below the frame 104. The pivot point about which the frame 104 rotates moves as the frame 104 rotates. The tilting mechanism 102 is configured to rotate the frame 104 about a longitudinal axis of an operating table or frame.

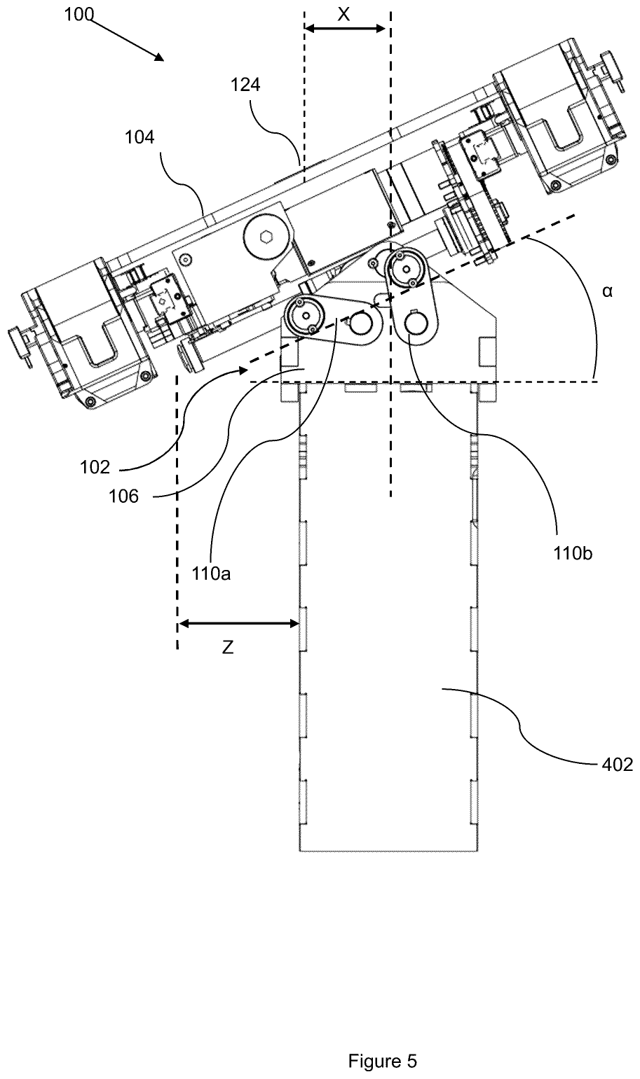

As shown in FIG. 5, the frame 104 is rotated or tilted by angle alphas (“α”), relative to a horizontal plane of the top of the pedestal. In this example, angle α is about 25 degrees. The angle of rotation is dependent on the required patient position. The frame 104 is also laterally displaced or displaced along a transverse axis by a distance X as the frame 104 is tilted by angle α. Distance X represents the horizontal displacement of the central point 124 of frame 104 relative to its original position or default position. In this example, distance X is about 80 mm. The distance X increases as angle α increases. The tilting mechanism 102 is configured to substantially maintain distance Z during rotation. Distance Z is the distance between a first end of the frame 104 and the pedestal 402. In this example, distance Z is around 110 mm. Lateral displacement of the frame 104 allows for a greater tilt angle α. Although FIG. 5 shows the frame 104 tilting in one direction only, the skilled person will appreciate that the frame 104 can also rotate in the other direction about the longitudinal axis of an operating table.

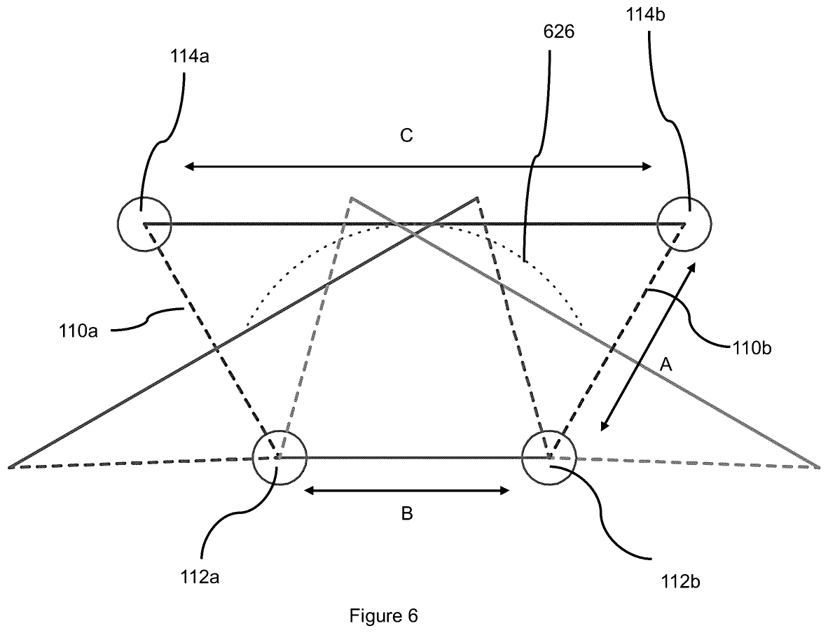

FIG. 6 shows a path 626 that the dynamic pivot point follows when the linear actuator is driven and as such the frame is moved from a resting position to a tilted position. This path has been interpolated and in practice would not be an arc of constant radius. The frame is configured to rotate about the dynamic pivot point as the dynamic pivot point follows the path. The path is determined by the length A of each of the links 110a and 110b, the distance B between the first pivot points 112a, 112b of the links, and the distance C between the second pivot points 114a, 114b of the links.

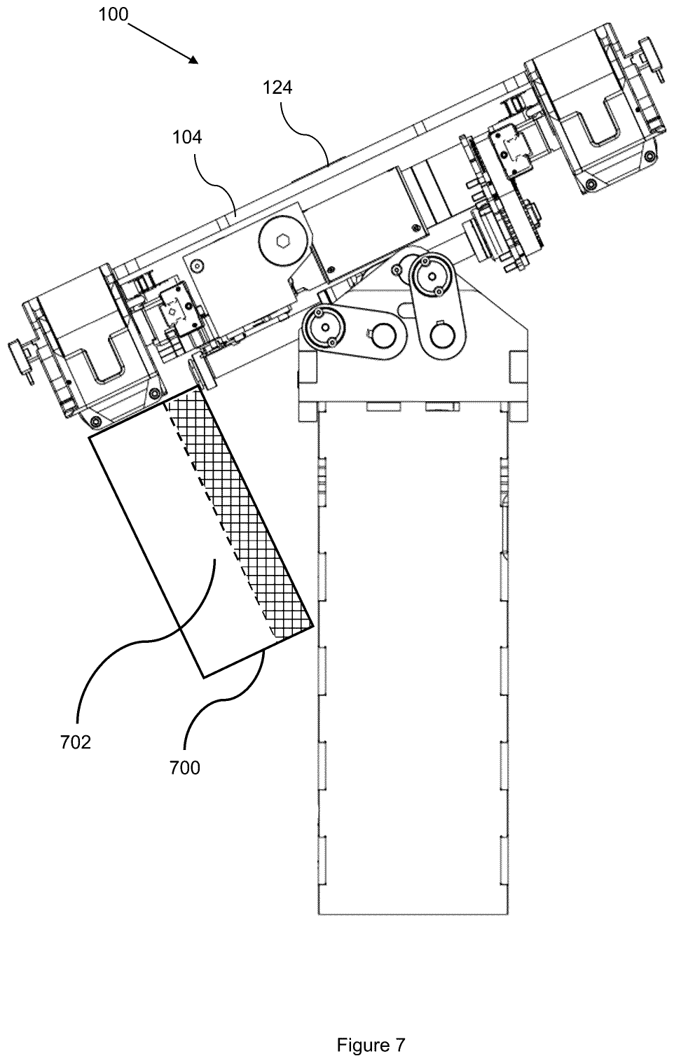

The operating table may comprise at least one accessory rail. The accessory rail is configured to at least one support accessory. The at least one accessory may be a robotic arm for performing robotic-assisted surgical procedures. FIG. 7 illustrates a boundary box 700 within which accessories can be coupled to the surgical table without risk of colliding with the pedestal. As can be seen, the tilting system according to the present disclosure increases the volume of the boundary box 700 as compared to the boundary box 702 (denoted by the dashed line) by the volume of the hatched section. This increase in volume enables larger accessories to be supported before collision with the pedestal of the operating table.

In use, the motor 120 is activated which in turn results in the linear actuator moving along the transverse axis of the frame 104. Because the linear actuator acts between the frame 104 and the chassis 106, and in particular due to the configuration of the carrier and the link sets 110, this linear movement results in rotation of the frame 104 about the dynamic pivot point. Movement of the linear actuator in a first direction along the transverse axis of the frame 104 causes tilting towards that first direction, and movement of the linear actuator in a second, opposing, direction along the transverse axis of the frame 104 causes tilting towards the second, opposing, direction.

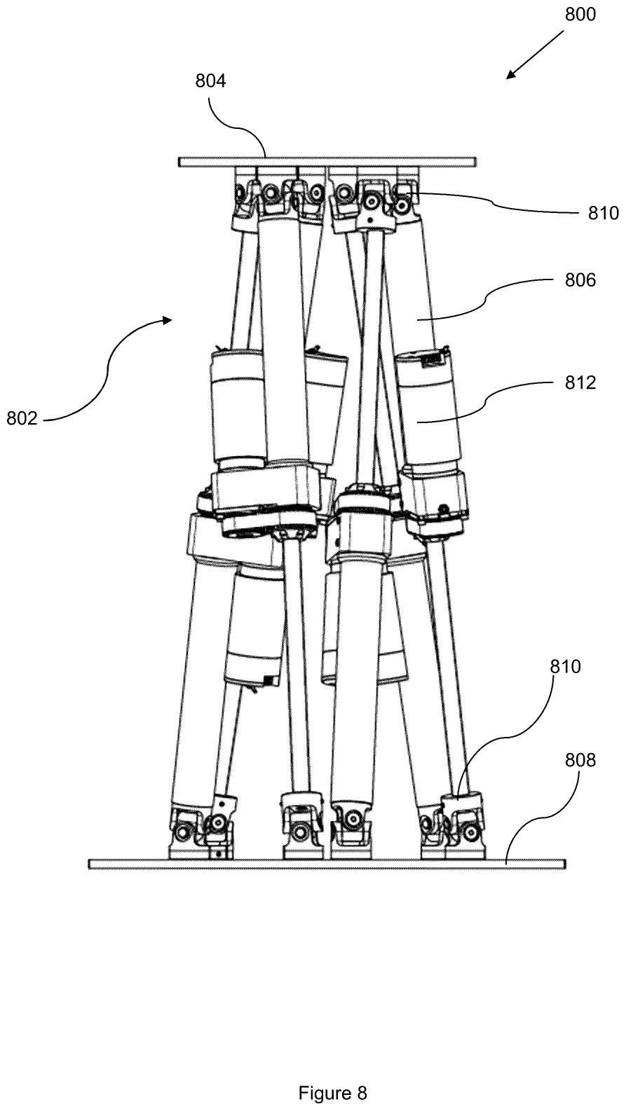

FIG. 8 illustrates an alternative example of the tilting system 800 for an operating table. The tilting system 800 comprises a frame 804 and a tilting mechanism 802. The frame 804 is configured to support a support surface for a patient. The tilting mechanism 802 is coupled to the frame 804. The tilting mechanism 802 is configured to rotate the frame 804 about the dynamic pivot point. The dynamic pivot point follows a predetermined path.

The tilting mechanism 802 comprises six linear actuators 806. Each linear actuator 806 is coupled at a first end to a base 808 and at a second end to the frame 804. The base 808 provides a stable support or foundation for the tilting system 800. The linear actuators 806 are arranged in a hexapod configuration. This allows for multi-axis movement. In particular, the six linear actuators 806 provide six degrees of freedom.

Each linear actuator 806 is attached to the base 808 and the frame 404 via a coupling joint 810. These coupling joints 810 allow for the necessary range of motion as the actuators 806 extend and retract. Each linear actuator 806 comprises a motor 812. The motor 812 is releasably coupled to the respective actuator 806. Each motor 812 is responsible for driving the extension and retraction of the respective actuator 806. Each actuator 806 can be moved independently of the other actuators 806. The tilting system 800 further comprises a controller configured to control each of the actuators 806. By coordinating the extension and retraction of the six actuators 806, the tilting mechanism 802 can achieve various tilting angles and positions, providing flexibility in patient positioning during surgical procedures.

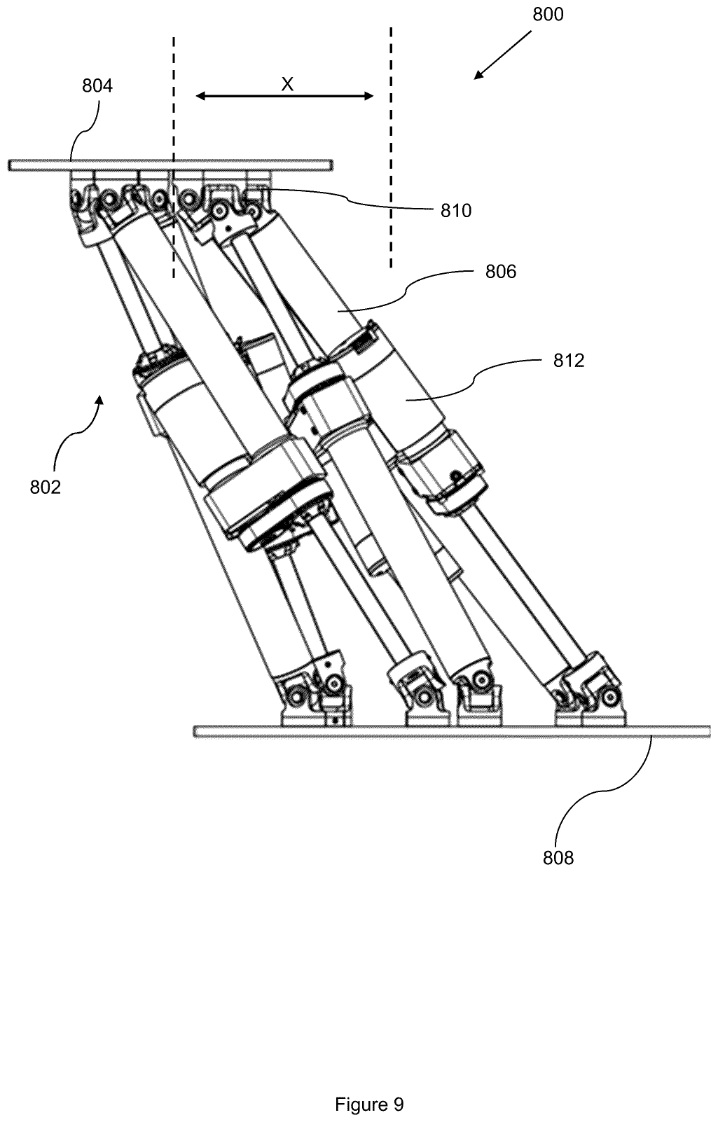

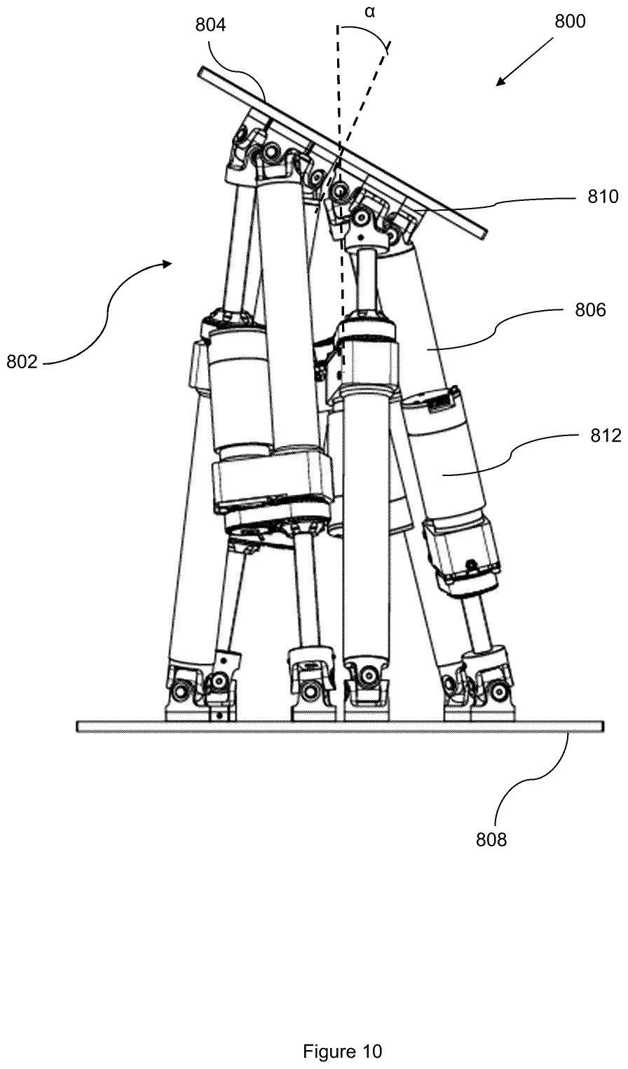

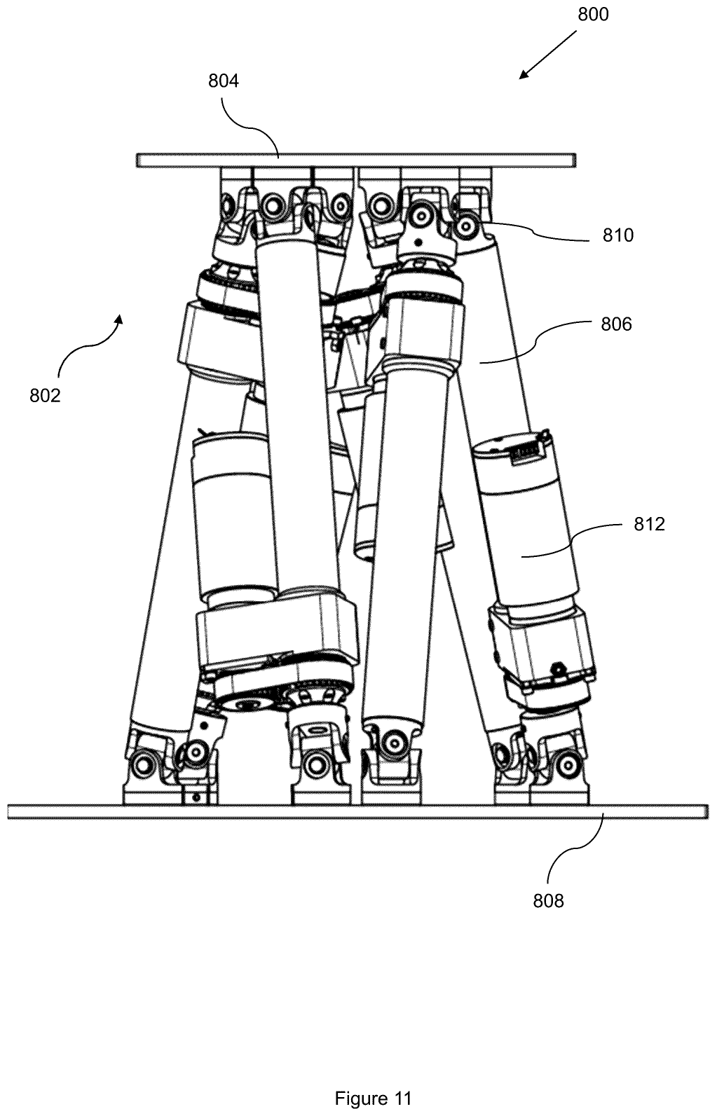

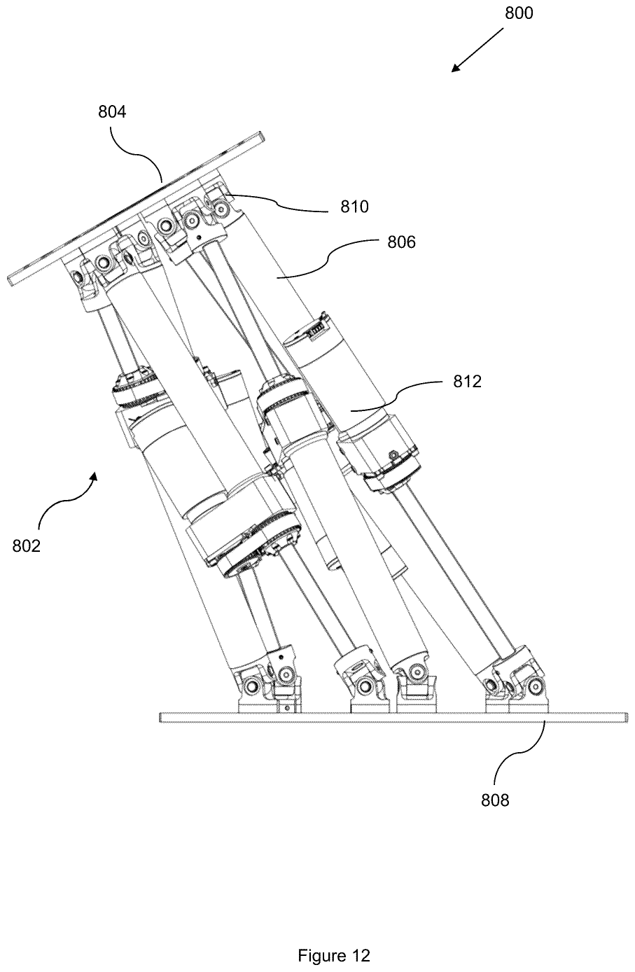

FIG. 9 illustrates the tilting system 800 in a position whereby the frame is displaced, transversely to the longitudinal axis of an operating table or support surface. The frame is displaced by distance X. Distance X is determined by position of the six actuators 806 and the controller. FIG. 10 illustrates the tilting system 800 when the frame 804 is rotated by angle α about the longitudinal axis of the operating table. FIG. 11 illustrates the tilting system in a retracted position, in comparison to the tilting system of FIG. 8. FIG. 12 illustrates the tilting system in a position whereby the frame has been laterally displaced and rotated about the dynamic pivot point. In use, the controller will instruct each of the motors 812 to adjust the position of the respective actuator 806 to achieve the desired support surface position.

While the disclosure has been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

Although this disclosure refers to specific embodiments, it will be understood by those skilled in the art that various changes in form and detail may be made without departing from the subject matter set forth in the accompanying claims.

1. A tilting system for an operating table comprising:
a frame for supporting a support surface for a patient; and
a tilting mechanism, coupled to the frame, configured to rotate the frame about a dynamic pivot point,
wherein, the dynamic pivot point follows a predetermined path.

2. The tilting system according to claim 1, wherein the tilting mechanism is configured to rotate the frame about a longitudinal axis of an operating table.

3. The tilting system according to claim 1, wherein the tilting mechanism is further configured to displace the frame, transversely to the longitudinal axis of an operating table, while it rotates about the dynamic pivot point.

4. The tilting system according to claim 1, wherein the dynamic pivot point is displaced from the frame in a direction of the tilting mechanism.

5. The tilting system according to claim 1, the tilting mechanism further comprising:
a chassis, for coupling the tilting system to a pedestal of an operating table;
at least one link set, the link set comprising at least one link pivotably coupled at a first end to the chassis and at a second end to the frame.

6. The tilting system according to claim 5, the tilting mechanism comprising a first link set disposed on a first lateral side of the tilting mechanism and a second link set disposed on a second lateral side of the tilting mechanism.

7. The tilting system according to claim 5, the at least one link set comprising two links, each link pivotably coupled at a first end to the chassis and at a second end to the frame.

8. The tilting system according to claim 5, further comprising a carrier pivotably coupled to the chassis, the carrier configured to support a shaft coupled, adjacent each end, to the frame, the shaft configured to move linearly, relative to the carrier, along a transverse axis of the frame while the frame rotates about the dynamic pivot point.

9. The tilting system according to claim 8, wherein the carrier and the shaft are configured to form a linear actuator.

10. The tilting system according to claim 9, wherein the carrier is configured such that the distance between the linear actuator and the top surface of the frame remains substantially constant during rotation.

11. The tilting system according to claim 9, further comprising a motor coupled to the frame, wherein the motor is configured to drive the linear actuator.

12. The tilting system according to claim 1, wherein the tilting mechanism comprises six linear actuators, each linear actuator coupled at a first end to a base and at a second end to the frame.

13. The tilting system according to claim 12, further comprising a controller configured to control the six linear actuators to rotate the frame about the dynamic pivot point.

14. An operating table comprising:
a tilting system according to claim 1; and
a support surface for a patient coupled to the frame.

15. A method of controlling an operating table, the method comprising rotating a support surface for a patient about a dynamic pivot point, wherein the dynamic pivot point follows a predetermined path.
